(19) United States
(12) Patent Application Publication
(10) Pub. No.: US 2019/0147211 A1
(43) Pub. Date: May 16, 2019

(54) FINGERPRINT SENSING DEVICE AND DRIVING METHOD OF FINGERPRINT SENSOR THEREOF

(71) Applicant: ILI TECHNOLOGY CORP., Hsinchu County (TW)

(72) Inventors: Cheng-Shian Shu, Hsinchu County (TW); Hu-Chi Chang, Hsinchu County (TW); Tzu Wei Liu, Hsinchu County (TW)

(73) Assignee: ILI TECHNOLOGY CORP., Hsinchu County (TW)

(21) Appl. No.: 16/182,634

(22) Filed: Nov. 7, 2018

(30) Foreign Application Priority Data
Nov. 13, 2017 (TW) 106139204

(51) Int. Cl. G06K 9/00

(52) U.S. Cl. CPC G06K 9/0002

(57) ABSTRACT

A fingerprint sensor of a fingerprint sensing device includes a first electrode strip and at least two second electrode strips adjacent to the first electrode strip. A driving method of the fingerprint sensor includes: providing a first voltage signal to the first electrode strip, and simultaneously providing at least two second voltage signal to the second electrode strips, respectively; and measuring a self capacitance value of the first electrode strip to determine whether a touch occurs at the fingerprint sensor, wherein the first voltage signal and each of the second voltage signals have a first voltage difference at a first time point and have a second voltage difference at a second time point, the first voltage difference and the second voltage difference are substantially equal, and the self capacitance value of the first electrode strip is performed at the second time point.

This application claims the benefit of Taiwan application Serial No. 106139204, filed Nov. 13, 2017, the subject matter of which is incorporated herein by reference.

### BACKGROUND OF THE INVENTION

### Field of the Invention

The invention relates to a fingerprint sensing device and a driving method of a fingerprint sensor thereof, and more particularly, to a fingerprint sensing device for detecting whether a finger is located on a fingerprint sensor and a driving method of a fingerprint sensor thereof.

### Description of the Related Art

With constantly innovating technologies, fingerprint sensors are extensively applied in various types of portable electronic devices, e.g., smart phones, tablet computers and laptop computers, so as to achieve identity verification through means of personal fingerprint recognition. In current fingerprint sensing technologies, capacitive fingerprint sensors can be integrated with an integrated circuit and can be easily packaged, and are thus most commonly and frequently utilized. In a conventional capacitive fingerprint sensor, ridges and valleys on a fingerprint are detected by a lattice structure formed by a plurality of driving electrodes and a plurality of sensing electrodes, so as to recognize a pattern of the fingerprint. When fingerprint recognition is performed, driving signals are sequentially transmitted to driving electrodes, and capacitance sensing amounts of the corresponding ridges and valleys are detected through sensing signals generated by sensing electrodes. However, a common electronic device is in a standby state before performing identity verification, and the standby power consumption of the electronic device is significantly increased if fingerprint recognition is persistently performed in the standby state. Although a fingerprint sensor can be activated by an additional function button on a current electronic device to prevent the fingerprint from persistently performing recognition in the standby state, such method still has certain shortcomings that need to be improved.

### SUMMARY OF THE INVENTION

It is an object of the present invention to provide a fingerprint sensing device and a driving method of a fingerprint sensor thereof to solve the above issues.

A driving method of a fingerprint sensor is provided according to an embodiment of the present invention. The fingerprint sensor includes a first electrode strip, at least second electrode strips adjacent to the first electrode strip, and a plurality of third electrode strips intersecting the first electrode strip and the second electrode strips, for detecting a fingerprint. The driving method includes: providing a first voltage signal to the first electrode strip, and simultaneously providing at least two second voltage signal to the second strips, respectively; and measuring a self capacitance value of the first electrode strip to determine whether a touch occurs at the fingerprint sensor, wherein the first voltage signal and each of the second voltage signals have a first voltage difference at a first time point and have a second voltage difference at a second time point, the first voltage difference and the second voltage difference are substantially equal, and the self capacitance value of the first electrode strip is measured at the second time point.

A fingerprint sensing device is provided according to an embodiment of the present invention. The fingerprint sensing device includes a fingerprint sensor and a control module. The fingerprint sensor is for sensing a fingerprint, and includes a first electrode strip, at least second electrode strips adjacent to the first electrode strip, and a plurality of third electrode strips intersecting the first electrode strip and the second electrode strips. The control module is electrically connected to the fingerprint sensor, provides a first voltage signal to the first electrode strip and at least two second voltage signals to the second electrode strips, respectively, and measures a self capacitance value of the first electrode strip. The first voltage signal and each of the second voltage signals have a first voltage difference at a first time point and have a second voltage difference at a second time point, the first voltage difference and the second voltage difference are substantially equal, and the self capacitance value of the first electrode strip is measured at the second time point.

In the fingerprint sensing device and the driving method of a fingerprint sensor of the present invention, the fingerprint sensor achieves objects of fingerprint sensor activation and fingerprint recognition, and further reduces a self capacitance value when the fingerprint sensor is not touched by a finger and a change in the self capacitance value due to a temperature change, thus preventing misjudgment of the fingerprint sensor under a temperature change, accelerating an unlocking time for the fingerprint sensor and enhancing user convenience.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a top schematic diagram of a fingerprint sensor according to a first embodiment of the present invention;

FIG. 2 is a timing schematic diagram of a first voltage signal provided to each first electrode strip and a ground signal provided to each remaining first axial electrode strip and each second axial electrode strip when a fingerprint sensor performs self capacitive touch sensing according to the first embodiment of the present invention;

FIG. 3 and FIG. 4 are respective schematic diagrams of coupling capacitance of the first electrode strips with the remaining axial first strips and second axial strips before touched by a finger and when touched by a finger according to the first embodiment of the present invention;

FIG. 5 is a schematic diagram of a relationship curve of temperature versus time and a relationship curve of self capacitance value measured from all first electrode strips versus time when a fingerprint sensor is not touched by a finger in a driving method according to the first embodiment of the present invention;

FIG. 6 is a relationship schematic diagram of self capacitance value measured versus time when a fingerprint performs self capacitive touch sensing according to the first embodiment of the present invention;

FIG. 7 is a functional block diagram of a fingerprint sensing device according to an embodiment of the present invention;

FIG. 8 is a top schematic diagram of a fingerprint sensor according to a second embodiment of the present invention;

FIG. 9 is a flowchart of a driving method of a fingerprint sensor according to the second embodiment of the present invention;

FIG. 10 is a timing schematic diagram of signals provided to a first electrode strip, a second electrode strip, a third electrode strip, a fourth electrode strip and a fifth electrode strip when a fingerprint sensor performs self capacitive touch sensing according to the second embodiment of the present invention;

FIG. 11 is a schematic diagram of a fingerprint sensor measuring a self capacitance value of a first electrode strip at a second time point according to another embodiment of the present invention;

FIG. 12 is a top schematic diagram of a fingerprint sensor according to a variation of the second embodiment of the present invention;

FIG. 13 is a flowchart of a driving method of a fingerprint sensor again performing self capacitive touch sensing according to another embodiment of the present invention;

FIG. 14 is a top schematic diagram of a fourth electrode strip of a fingerprint sensor according to another embodiment of the present invention;

FIG. 15 and FIG. 16 are schematic diagrams of coupling capacitance of each first electrode strip with a first second electrode and a third electrode strip before touched by a finger and when touched by a finger according to the second embodiment of the present invention;

FIG. 17 is a schematic diagram of a relationship curve of temperature versus time and a relationship curve of self capacitance value measured from all first electrode strips versus time when a fingerprint sensor is not touched by a finger in a driving method according to the second embodiment of the present invention;

FIG. 18 is a schematic diagram of self capacitance value measured versus time when a fingerprint performs self capacitive touch sensing according to the second embodiment of the present invention; and

FIG. 19 is a timing schematic diagram of a first voltage signal and a second voltage signal according to a third embodiment of the present invention.

### DETAILED DESCRIPTION OF THE INVENTION

To enable a person skilled in the art to further understand the present invention, specific embodiments of the present invention are given with the accompanying drawings below to describe the constituents and expected effects of the present invention. The components in the drawings in the description below are illustrative and are not drawn to actual ratios. To clearly depict the present invention, the detailed ratios may be adjusted according to design requirements. Further, the numbers and sizes of the components in the drawings are illustrative, and are not to be construed as limitations to the scope of the disclosure.

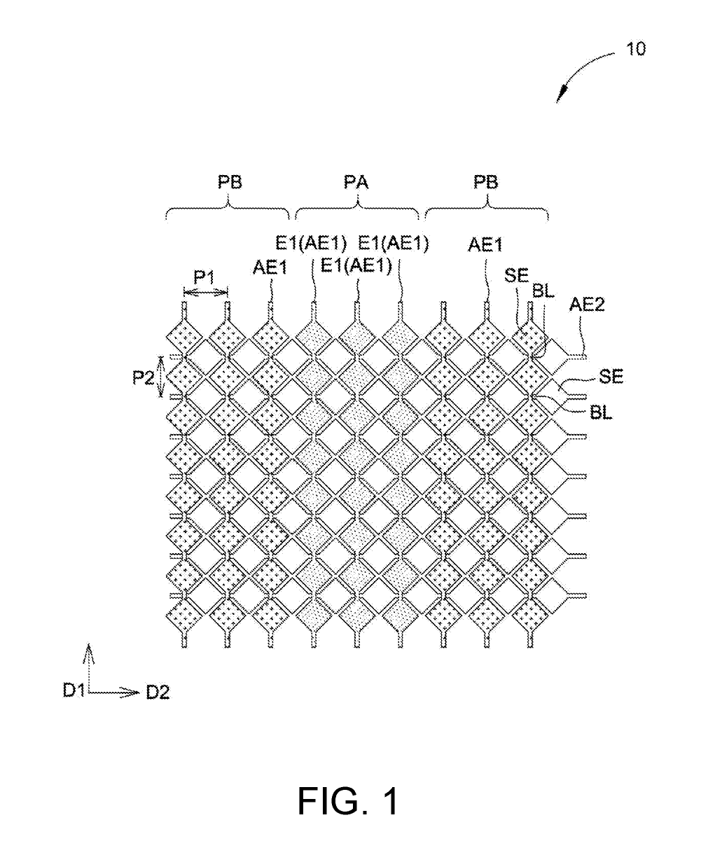

FIG. 1 shows a top schematic diagram of a fingerprint sensor according to an embodiment of the present invention. As shown in FIG. 1, a fingerprint sensor 10 includes a plurality of first axial electrode strips AE1 and a plurality of axial second electrode strips AE2. The first axial strips AE1 extend along a first direction D1 and are mutually separated, and the second axial electrode strips AE2 extend along a second direction D2 and are mutually separated, such that the first axial electrode strips AE1 and the second electrode strips AE2 mutually intersect and can detect a fingerprint through mutual coupling capacitance. In this embodiment, each of the first axial electrode strips AE1 and second axial electrode strips AE2 may include a plurality of sensing electrodes SE and a plurality of bridge lines BL. The bridge lines BL corresponding to the same first axial electrode strip AE are for connecting every two adjacent sensing electrodes SE arranged in the first direction D1 to form the first axial electrode strip AE1, and the bridge lines BL corresponding to the same second axial electrode strip AE2 are for connecting every two adjacent sensing electrodes SE arranged in the second direction D2 to form the second axial electrode strip AE2. The structures of the first axial electrode strips AE1 and the second electrode strips AE2 of the present invention are not limited to the above example, and may also be other types of mutual capacitive touch sensing structures. In this embodiment, a part PA of the first axial electrode strips AE1 include a plurality of first electrode strips E1 and may be used for independently performing self capacitive touch sensing. That is to say, when the first electrode strips E1 perform self capacitive touch sensing, the remaining part PB of the first axial electrode strips AE1 and all of the second axial electrode strips AE2 do not perform sensing. For example, the number of the first axial electrode strips AE1 may be 110, the number of the second axial electrode strips AE2 may be 96, and the number of the first electrode strips E1 may be 16.

It should be noted that, a user of the fingerprint sensor 10 for self capacitive touch sensing can activate fingerprint recognition without pressing a button. Once self capacitive touch sensing determines that the fingerprint sensor 10 is touched by a finger, the fingerprint sensor 10 immediately performs fingerprint recognition, such that a user is enabled to simultaneously activate the fingerprint sensor 10 and fulfill fingerprint recognition in one single finger touch. Because self capacitive touch sensing of the fingerprint sensor 10 can be performed through merely a part of the first axial electrode strips AE1 (i.e., the first electrode strips E1), the standby power consumption of the electronic device can be significantly reduced.

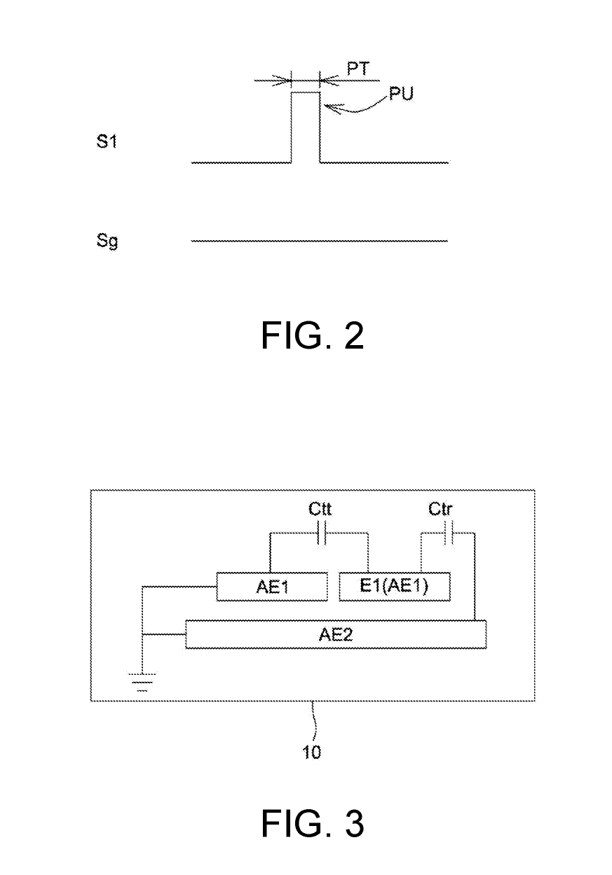

FIG. 2 shows a timing schematic diagram of a first voltage signal provided to the first electrode strips E1 and a ground signal provided to the remaining part PB of the first axial electrode strips AE1 and the second axial electrode strips AE2 when a fingerprint sensor performs self capacitive touch sensing according to a first embodiment of the present invention. Referring to FIG. 2 as well as FIG. 1, a self capacitive touch sensing method of the fingerprint sensor 10 of the present invention is described below. As shown in FIG. 2, a plurality of first voltage signals S1 are first provided to the first electrodes E1, respectively, and a ground signals Sg is simultaneously provided to the first axial electrode strips AE1 of the remaining part PB and the second axial electrode strips AE2. In this embodiment, when self capacitive touch sensing is performed, the first voltage signal S1 has a pulse PU in a pulse period PT, and the first axial electrode strips AE1 of the remaining part PB and the second axial electrode strips AE2 are all electrically connected to the ground terminal, such that the first axial electrode strips AE1 of the remaining part PB and the second axial electrode strips AE2 transmit the ground signals Sg. Next, in the pulse period PT, the self capacitance value of each first electrode strip E1 is measured to further determine whether a finger touches the fingerprint sensor 10. More specifically, the self capacitive value can be obtained by measuring a charging/discharging amount of each first electrode strip E1. Because the self capacitance values of each first electrode E1 before and after touched by the fingerprint sensor 10 are different, whether a finger touches the fingerprint sensor 10 can be learned by comparing the self capacitance values obtained from the two situations. For example, when the measured self capacitance value is smaller than a predetermined threshold, it is determined that the fingerprint sensor 10 is not touched by a sensor. Conversely, when the self capacitance value is greater than or equal to the predetermined threshold, it is determined that the finger the fingerprint sensor 10 is touched by a finger. The predetermined threshold may be a self capacitance value before a finger touches the fingerprint sensor 10 or the self capacitance value added by a predetermined value.

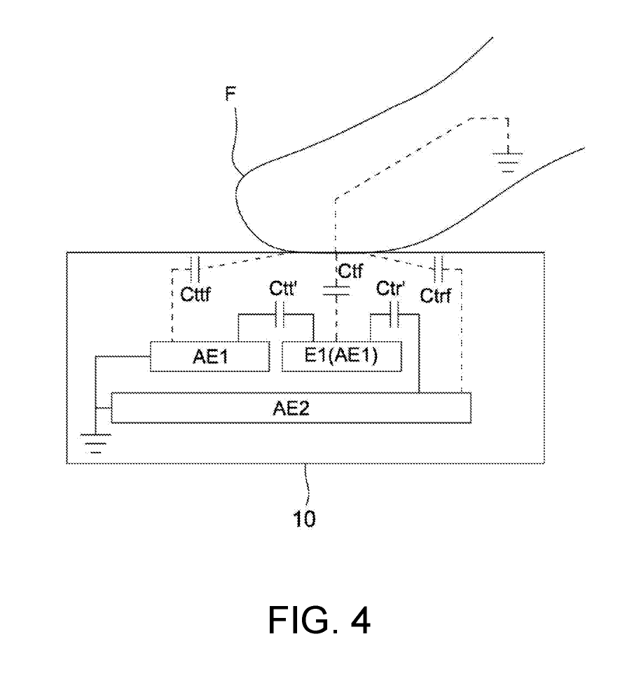

The voltage of the pulse PU is different from the voltage of the ground signal Sg. Thus, a voltage difference greater than zero exists between the first electrode strips E1 and the remaining part PB of the first axial electrode strips AE1 and between the first electrode strips E1 and the second axial electrode strips AE2, such that coupling capacitance is generated between the first electrode strips E1 and the first axial electrode strips AE1 of the remaining part PB and between the first electrode strips E1 and the second axial electrode strips AE2. Hence, the self capacitance value measured from each first electrode strip E1 is easily affected by a change in these coupling capacitance values. Specific details are given below. FIG. 3 and FIG. 4 respectively show schematic diagrams of coupling capacitance of the first electrode strips E1 in regard to the remaining first axial electrode strips AE1 and the second axial electrode strips AE2 before touched by a finger and when touched by a finger. As shown in FIG. 3, before the fingerprint sensor 10 is touched by a finger, a self capacitance value Cn measured from each first electrode strip E1 can be represented by equation (1) below:

Cn=Ctt+Ctr (1)

In equation (1), Ctt is the coupling capacitance value of each first electrode strip E1 in regard to remaining part PB of the first axial electrode strips AE1, and Ctr is the coupling capacitance value of the first electrode strips E1 in regard to the second axial electrode strips AE2 when the fingerprint sensor 10 is not touched by a finger. It is evident that, before the fingerprint sensor 10 is touched by a finger, the self capacitance value Cn measured from each first electrode strip E1 consists the coupling capacitance value Ctt of the first electrode strips E1 in regard to the first axial electrode strips AE1 of the remaining part PB and the coupling capacitance value Ctr of each first electrode strip E1 in regard to the second axial electrode strips AE2.

As shown in FIG. 4, when the touch sensor 10 is touched by a finger, the finger F generates coupling capacitance values Ctf, Cttf and Ctrf with the first electrode strips E1, the first axial electrode strips AE1 of the remaining part PB, and the second axial electrode strips AE2. Thus, the self capacitance value Ct of the first electrode strip E1 when the fingerprint sensor 10 is touched by a finger F can be represented by equation (2) below:

Ct=Ctt′+Ctr′+Ctf (2)

In equation (2), Ctt′ is the coupling capacitance value of each first electrode strip E1 in regard to the first axial electrode strips AE1 of the remaining part PB when the first electrode strips E1 is touched by the finger F, Ctr′ is the coupling capacitance of each first electrode strip E1 in regard to the second axial electrode strips AE1 when the fingerprint sensor 10 is touched by the finger F, and Ctf is the coupling capacitance value of each first electrode strip E1 in regard to the finger F. Thus, a self capacitance change ΔC of each first electrode strip E1 when the fingerprint sensor 10 is touched by the finger F and when the fingerprint sensor 10 is not touched by the finger F can be calculated through equation (1) and equation (2), as equation (3) below:

ΔC=Ct−Cn=(Ctt′−Ctt)+(Ctr′−Ctr)+Ctf (3)

It is known that, the self capacitance change ΔC measured is associated with the coupling capacitance values Ctt and Ctt′ of each first electrode strip E1 in regard to first axial electrode strips AE1 of the remaining part PB and the coupling capacitance value Ctr and Ctr′ of each first electrode strip E1 in regard to the second axial electrode strips AE2. However, because a gap P1 between two adjacent first axial electrode strips E1 and a gap P2 between two adjacent second axial electrode strips AE2 in the fingerprint sensor 10 are extremely small, e.g., smaller than 75 μm, the gaps P1 and P2 are likely changed due to a temperature change, such that the coupling capacitance values Ctt and Ctt′ of each first electrode strip E1 in regard to first axial electrode strips AE1 of the remaining part PB and the coupling capacitances Ctr and Ctr′ of each first electrode strip E1 in regard to the second axial electrode strips AE2 are also changed due to the temperature change. Thus, the self capacitance change ΔC measured by the self capacitive touch sensing method of the embodiment is easily affected by a temperature change.

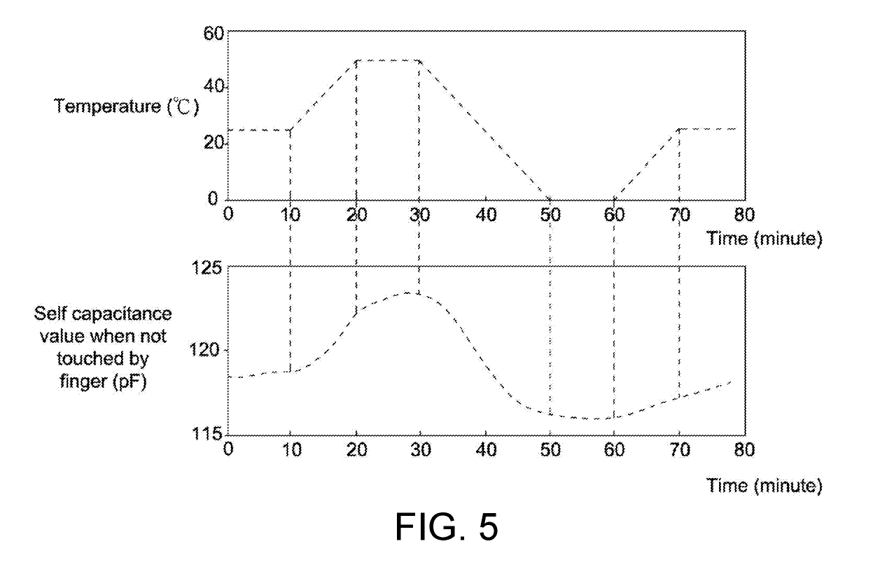

FIG. 5 shows a relationship schematic diagram of a relationship of temperature versus time and a relationship of a self capacitance value measured from all first electrode strips versus time in a driving method according to the first embodiment when a fingerprint sensor is not touched by a finger. It is known from FIG. 5 that, when the temperature rises from 25 to 50 degrees Celsius, the self capacitance value rises by 4.7 pF; when the temperature drops from 50 to 0 degrees Celsius, the self capacitance value drops by 7.6 pF. However, a self capacitance change ΔC measured from all first electrode strips by the self capacitive touch sensing method when the finger touches/not touch the fingerprint sensor 10 is merely approximately 1.6 pF; that is to say, the amount of change measured in the self capacitance value resulted from the temperature change when the fingerprint sensor 10 is not touched is very likely greater than the measured self capacitance change ΔC. Thus, the self capacitance changed caused by a temperature change easily causes the fingerprint sensor 10 to judge such self capacitance change as the finger touching the fingerprint sensor, resulting in misjudgment.

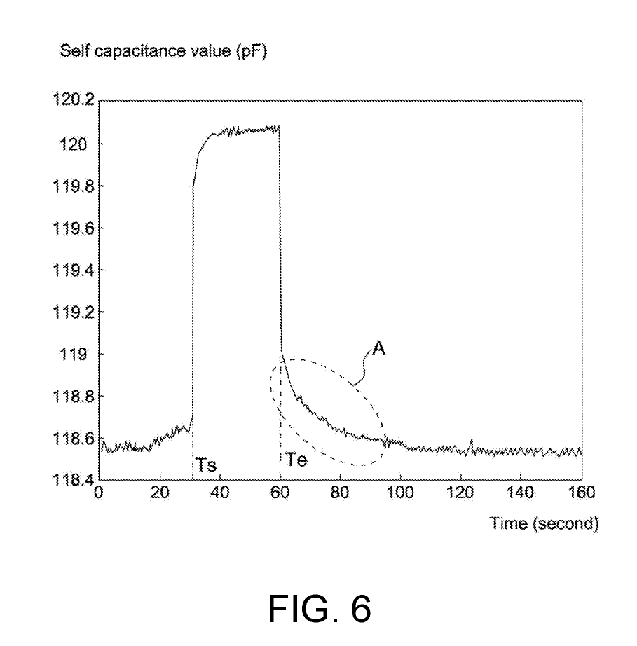

To determine a finger touch through a self capacitance change faces even more challenges. FIG. 6 shows a relationship schematic diagram of a self capacitance value measured versus time when a fingerprint sensor performs self capacitive touch sensing according to the first embodiment of the present invention. As shown in FIG. 6, a finger starts to touch the fingerprint sensor 10 at a starting time point Ts and leaves the fingerprint sensor 10 at an ending time point Te. In this embodiment, when the finger has just left the fingerprint sensor 10, the self capacitance value detected by the fingerprint sensor 10 (e.g., the self capacitance value in a region A in FIG. 6) is greater than the self capacitance value when the fingerprint sensor 10 is not touched by a finger. The self capacitance value in the region A is also referred to as a residual sensing value, and thus the fingerprint sensor 10 may easily consider that the finger is still touching the fingerprint sensor 10 in a period after the ending time point Te. Accordingly, the fingerprint sensor 10 needs to wait for at least a certain period, e.g., 10 seconds, for the self capacitance value to return to the self capacitance value when the fingerprint sensor 10 is not touched by a finger. That is to say, the fingerprint sensor 10 cannot perform determination until the self capacitance value returns to be smaller than the predetermined threshold. As a result, the self capacitive touch sensing method of the embodiment is incapable of immediately recognizing the change caused by repeated finger touches, such that the time for the fingerprint sensor 10 to recognize repeated finger touches is prolonged. For example, when a user unlocks through the fingerprint sensor 10, this waiting period causes utilization inconvenience of the user.

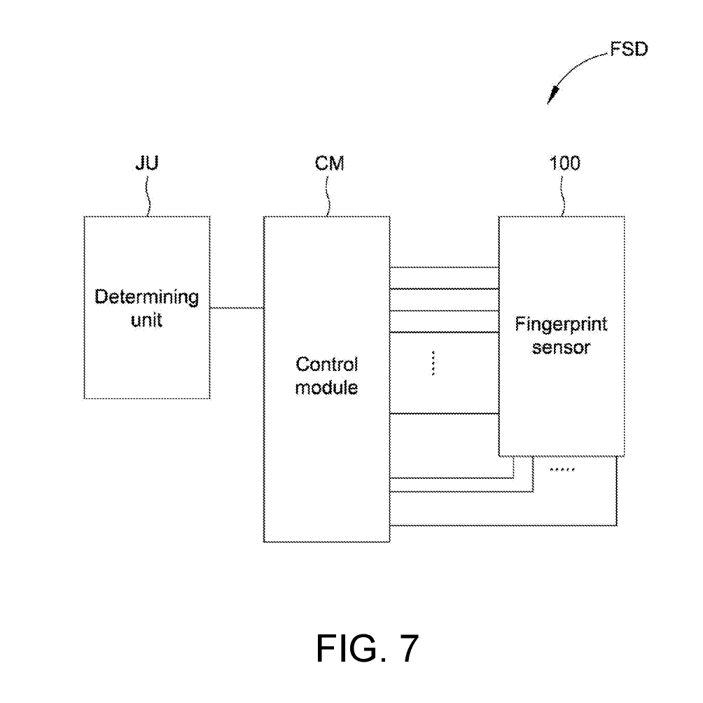

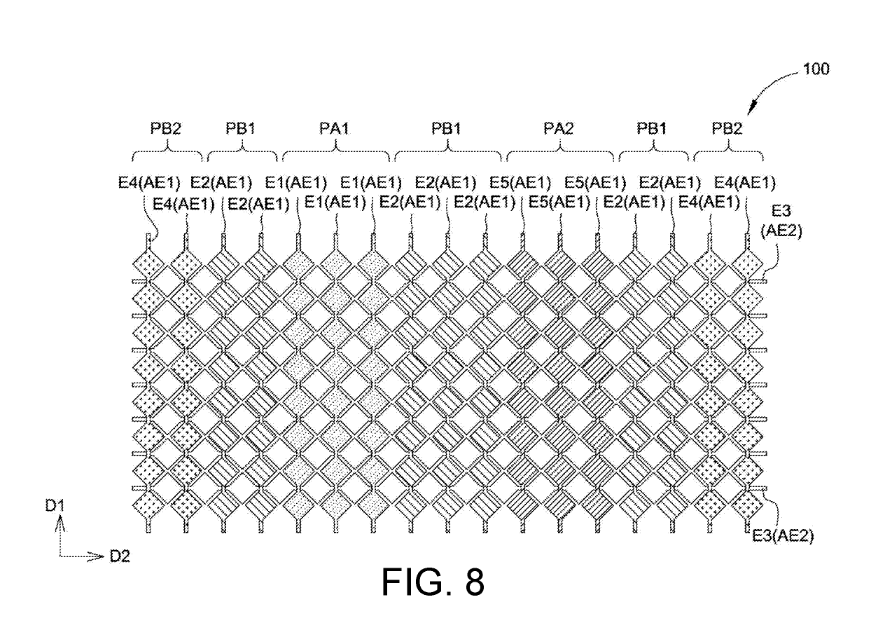

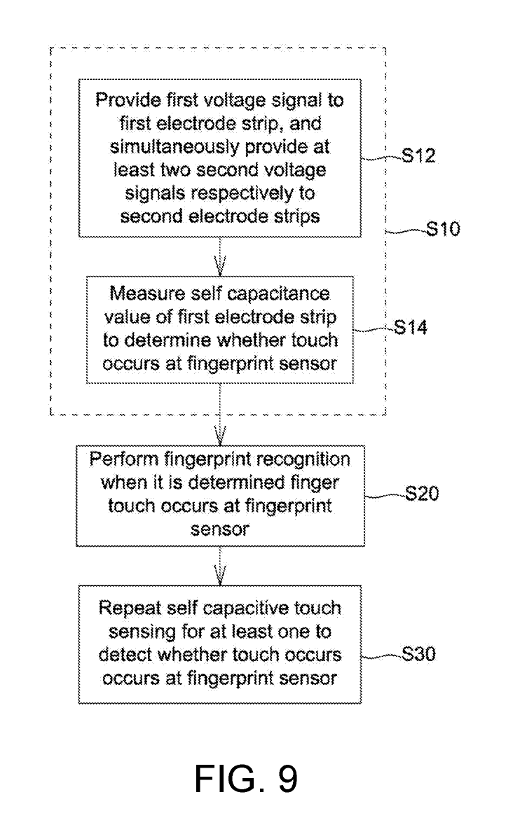

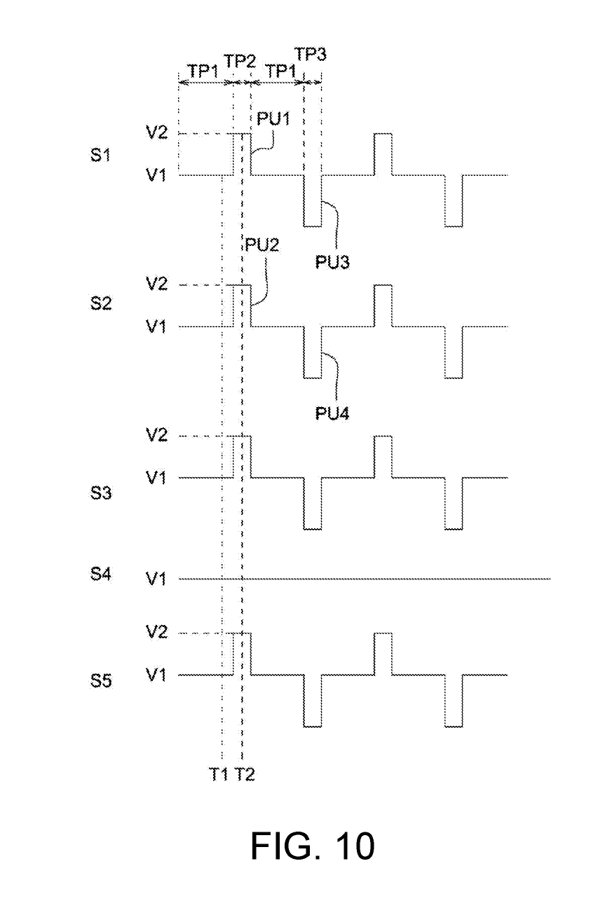

In view of the above, the present invention further provides a fingerprint sensing device and a driving method of a fingerprint sensor thereof in the embodiment below, so as to solve the issues of the self capacitive touch sensing method of the first embodiment. Refer to FIG. 7 to FIG. 10. FIG. 7 shows a functional block diagram of a fingerprint sensing device according to an embodiment of the present invention. FIG. 8 shows a top schematic diagram of a fingerprint sensor according to a second embodiment of the present invention. FIG. 9 shows a flowchart of a driving method of a fingerprint sensor according to the second embodiment of the present invention. FIG. 10 shows a timing schematic diagram of signals provided to a first electrode strip, a second electrode strip and a third electrode strip when a fingerprint sensor performs self capacitive touch sensing according to the second embodiment of the present invention. As shown in FIG. 7, a fingerprint sensing device FSD may include a fingerprint sensor 100 and a control module CM. The control module CM is electrically connected to the fingerprint sensor 100, and may include, for example but not limited to, multiple driving control units respectively electrically connected to the corresponding first axial electrode strips AE1, and multiple detecting units respectively electrically connected to the corresponding second axial electrode strips AE2. The control module CM can be used to control the fingerprint sensor 100 to perform self capacitive touch sensing or perform mutual capacitive touch sensing. In this embodiment, the fingerprint sensing device FSD may further include a determining unit JU for determining whether a touch occurs at the fingerprint sensor 100 according to the self capacitive touch value measured by the control module CM. In another embodiment, the determining unit JU may also be integrated in the control module CM.

Further, as shown in FIG. 8, compared to the first embodiment, the first axial electrode strips AE1 further include at least two second electrode strips E2 adjacent to the first electrode strip E1 in addition to the first electrode strip E1. The first axial electrode strips AE1 at least include a first part PA1 and at least two second parts PB1 adjacent to the first part PA1, with the first part PA1 arranged between the second parts PB1. Each first axial electrode strips AE1 in the first part PA1 is the first electrode strip E1. In this embodiment, the first electrode strip E1 may be one or plural in quantity. Each first axial electrode strip AE1 in the second part PB1 is the second electrode strip E2, and the second electrode strip E2 in each second part PB1 may be at least one in quantity. Further, the second axial electrode strips AE2 may further include a plurality of third electrode strips E3; that is, at least a part of the second axial electrode strips AE2 may be third electrode strips E3.

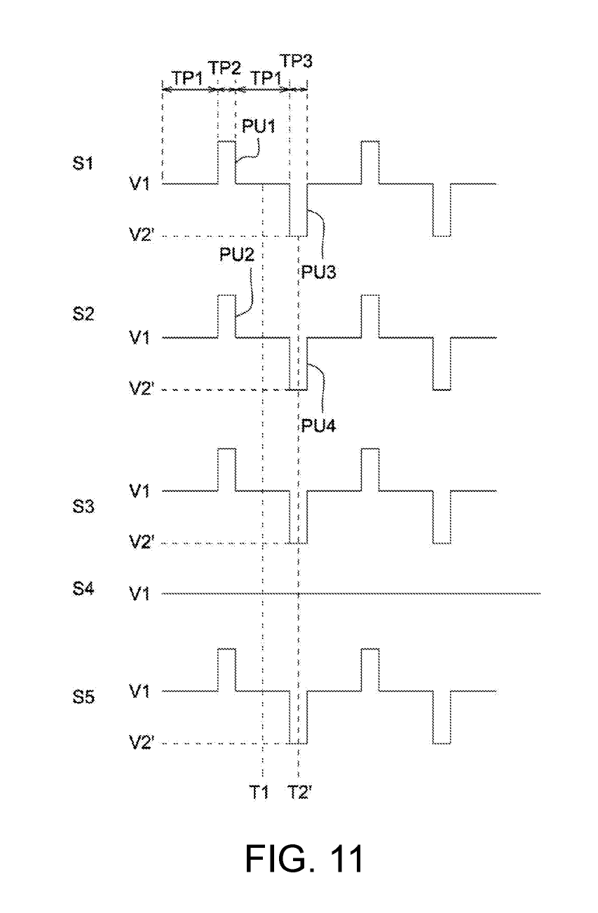

As shown in FIG. 9 and FIG. 10, the driving method provided by the embodiment further includes following steps. First, the control module CM performs step S10 of self capacitive touch sensing to determine whether a touch occurs at the fingerprint sensor 100, e.g., determining a touch of a finger. Step 310 in this embodiment may include first performing step S12 to have the control module CM provide a first voltage signal S1 to the first electrode strip E1, and then performing step S14 to have the control module CM to measure the self capacitance value of the first electrode strip E1. Next, the control module CM may transmit the measured self capacitive value to the determining unit JU, which determines according to the self capacitance value measured by the control module CM whether a touch occurs at the fingerprint sensor 100. The quantity of the first voltage signal S1 may be determined by the quantity of the first electrode strip E1, and a plurality of first voltage signals S1 respectively transmitted to a plurality of first electrode strips E1 are given as an example below; however, the present invention is not limited thereto. Compared to the self capacitive touch sensing method of the first embodiment, step S12 of providing the first voltage signal S1 in this embodiment further includes having the control module CM respectively provide at least two second voltage signals S2 to the second electrode strips E2. Wherein, each first voltage signal S1 and each second voltage signal S2 have a voltage difference at the first time point T1 and have a second voltage at the second time point T2, and the first voltage difference and the second voltage difference are substantially equal. In this embodiment, the control module CM does not measure the self capacitive value of the first electrode strip E1 of the fingerprint sensor 100 at the first time point T1, and measures the self capacitive value of the second electrode strip E2 of the fingerprint sensor 100 at the second time point T2. Further, each first voltage signal S1 and each second voltage signal S2 have the same first voltage V1 at the first time point T1 and have the same second voltage V2 at the second time point, wherein the second voltage V2 is greater than the first voltage V1. More specifically, each first voltage signal S1 and each second voltage signal S2 have the first voltage V1 in each first time interval TP1, the first time point T1 is within the first time interval TP1, each first voltage signal S1 has a first pulse PU1 in each second time interval TP2, each second voltage signal S2 has a second pulse PU2 in each second time interval TP2, and each second time interval TP2 is located between any two adjacent first time intervals TP1. Further, the valley voltage of each first pulse PU1 and the valley voltage of each second pulse PU2 may be the same first voltage V1, and the peak voltage of each first pulse PU1 and the peak voltage of each second pulse PU2 may be the same second voltage V2. Preferably, each first pulse voltage PU1 may be synchronous with each second pulse PU2. Further, each first voltage signal S1 may selectively include a third pulse PU3 in each third time interval TP3, each second voltage signal S2 may selectively include a fourth pulse PU4 in each third time interval TP3, and each third time interval TP3 is located between two adjacent first time intervals TP1. In this embodiment, the second time intervals TP2 and the third time intervals TP3 are sequentially and alternatingly arranged. Further, the valley voltage of each third pulse PU3 may be equal to the peak voltage of each fourth pulse PU4, and the peak voltage of each third pulse PU3 and the peak voltage of each fourth pulse PU4 are the same first voltage V1. Preferably, each third pulse PU3 is equal to and synchronous with each fourth pulse PU4. For example, each first voltage signal S1 and each second voltage signal S2 may be, for example but not limited to, substantially the same. It should be noted that, the second electrode strip E2 provided with the second voltage signal S2 and adjacent to the first electrode strip E1 is not used for measuring the self capacitance value. Further, the first voltage signal S1 provided to the first electrode strip E1 and the second voltage signal S2 provided to the second electrode strip E2 may be the same or substantially the same. Thus, the voltage difference between each first electrode strip E1 and each second electrode strip E2 may be kept at 0 and there is no coupling capacitance therebetween to be measured, such that the measured self capacitance value is not affected by the coupling capacitance between the first electrode strip E1 and the second electrode strip E2. In another embodiment, as shown in FIG. 11, the second time point T2′ at which the control module CM measures the self capacitance value of the first electrode strip E1 may also be located in the third time interval TP3 (i.e., corresponding to the third pulse PU1 of each first voltage signal S1 and the fourth pulse PU2 of each second voltage signal S2). At this point, each second voltage V2′ may be the valley voltage of each third pulse PU1, the first voltage V1 may be the peak voltage of each third pulse PU1, and the second voltage V2′ is smaller than the first voltage V1.

Refer to Table-1 as well as FIG. 1. Table-1 represents the percentage of influences that the first axial electrode strips AE1 of the remaining part PB have upon the self capacitance value of the first electrode strip E1 when the fingerprint sensor 10 is driven according to the first embodiment of the present invention. Taking one single first electrode E1 for instance, L1 to L4 respectively represent the remaining part PB of the first axial electrode strips AE1 located on the left of the first electrode strip E1 and sequentially distanced farther away from the first electrode strip E1, and R1 to R4 respectively represent the first axial electrode strips AE1 of the remaining part PB located on the right of the first electrode strip E1 and sequentially distanced farther away from the first electrode strip E1.

TABLE 1

| | Percentage of influences upon self |
|---|---|
| Position of first axial | capacitance value of first electrode strip |
| electrode strip AE1 | E1 |
| L4 | 1% |
| L3 | 1% |
| L2 | 4% |
| L1 | 44% |
| R1 | 44% |
| R2 | 4% |
| R3 | 1% |
| R4 | 1% |

It is known from Table-1 that, in the remaining part PB, the first axial electrode strip AE1 distanced farther away from the first electrode strip E1 has smaller influences on the self capacitance value measured from the first electrode strip E1, and the first axial electrode strip AE1 adjacent to the first electrode strip E1 has far greater influences on the self capacitance value than other first axial electrode strips AE1 that are not adjacent to the first electrode strip E1. More specifically, the percentages of the two first axial electrode strips AE (L1 and R1) adjacent to the first electrode strip E1 individually occupy the overall influences by as high as 44%. Accordingly, as high as 88% of the overall influences can be eliminated by simply eliminating the two first axial electrode strips AE (L1 and R1) adjacent to the first electrode strips E1.

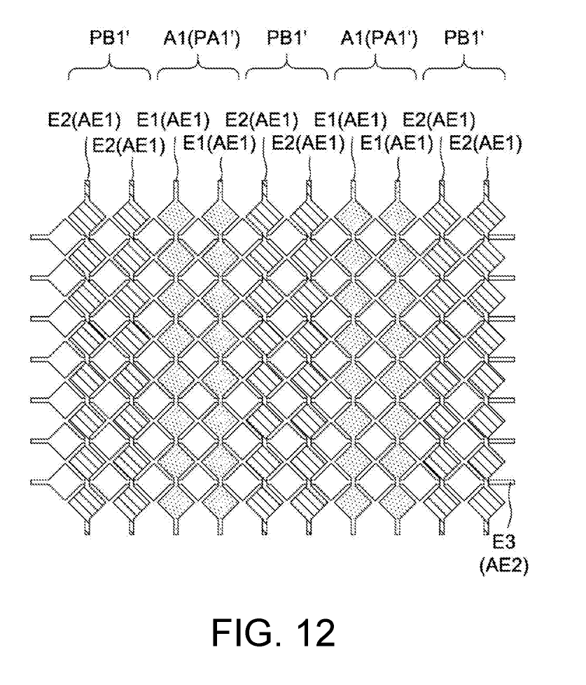

Thus, as shown in FIG. 8, to reduce the quantity of the second voltage signals S2 in a situation that the influences on the self capacitance value of the first electrode E1 from the coupling capacitance between other first axial electrode strips AE1 are to be reduced, the fingerprint sensor 100 of the embodiment may design only two first axial electrode strips AE1 adjacent to the first electrode strip E1 as second electrode strips E2, such that the first electrode strips E1 may be placed between the two second electrode strips E2, and no second electrode strip E2 is arranged between two adjacent first electrode strips E1. However, the present invention is not limited to the above example. In a variation embodiment, the quantity of the second electrode strips E2 located on any side or both sides of the first electrode strip E1 may also be plural, and these second electrode strips E2 are first axial electrode strips AE1 arranged together. In a fingerprint sensor 100′ in another variation embodiment, as shown in FIG. 12, at least one second electrode strip E2 may be provided between two adjacent first electrode strips E1. In other words, a first part PA1′ may be further divided into at least two sub-parts A1, the first axial electrode strips AE1 may include three second parts PB1′, and the sub-parts A1 of the first part PA1′ are separated, such that each sub-part A1 is provided between two adjacent second parts PB1′. The quantity of the second electrode strips E2 in each second part PB1′ may be at least one.

Further, in addition to the first electrode strips E1 and the second electrode strips E2, at least two first electrode strips AE1 of third parts PB2′ may include a plurality of fourth electrode strips E4, and each second part PB1 is provided between the third part PB2 and the first part PA1 that are adjacent. That is to say, the fourth electrode strips E4 may be the remaining first axial electrode strips AE1. In step S12, the control module CM at the same time provides a fourth voltage signal S4 to the fourth electrode strip E4, and the voltage of the fourth voltage signal S4 is equal to that of the first voltage V1, i.e., the fourth voltage signal S4 is a ground signal. Due to the second electrode strip E2 provided between the first electrode strip E1 and the fourth electrode strip E4, the influences that the fourth electrode strip E4 has on the self capacitance value measured from the first electrode strip E1 is far smaller than those of the second electrode strip E2. Further, because the second electrode strip E2 is not used for measuring the self capacitance value, the coupling capacitance between the fourth electrode strip E4 and the second electrode strip E2 does not affect the finger touch detection. Therefore, the standby power consumption of the electronic device is further lowered by providing a ground signal to the fourth electrode strip E4.

As shown in FIG. 9 and FIG. 10, in this embodiment, step S12 of providing the first voltage signal may further include having the control module CM provide a plurality of third voltage signals S3 to the third electrode strips E3, respectively, wherein each of the first voltage signals S1 and each of the third voltage signals S3 have a third voltage difference at the first time point T1 and a fourth voltage difference at the second time point T2, and the third voltage difference and the third voltage difference are substantially equal. For example, each of the first voltage signals S1 may be substantially the same as each of the third voltage signals S3. Thus, the voltage signal between each first electrode strip E1 and each third electrode strip E3 may be maintained 0, and no coupling capacitance therebetween is measured, such that the self capacitance value measured from the first electrode strip E1 is not affected by the coupling capacitance between the first electrode strip E1 and the third electrode strip E3. Preferably, the quantity of the third electrode strips E3 may be equal to the quantity of the second axial electrode strips AE2, in a way that all of the second axial electrode strips AE2 intersecting the first electrode strips E1 are provided with the third voltage signal S3 so as to reduce the influences on the self capacitance value of the first electrode strips E1 from the coupling capacitance of the first electrode strips E1 and the second axial electrode strips AE2.

In this embodiment, the first axial electrode strips AE1 may further include at least one fifth electrode strip E5, which may be separately used for independently performing self capacitive touch sensing to detect whether the fingerprint sensor 100 is touched by a finger. That is to say, the first axial electrode strip AE1 may include a fourth part PA2, in which the first axial electrode strip AE1 may be the fifth electrode strip E5. Thus, step S12 of providing the first voltage signal may further include having the control module CM provide a plurality of fifth voltage signals S5 to the fifth electrode strips E5, respectively, and step S14 of measuring the self capacitance value of the first electrode strip E1 may further include having the control module CM measure the self capacitance values of the fifth electrode strips E5. In this embodiment, the fifth electrode strip E5 may be one or plural in quantity. For example, each first voltage signal S1 may be substantially the same as each fifth voltage signal S5. The quantity of the fifth electrode strips E5 may be, for example, 16. Further, the fifth electrode strip E5 may be non-adjacent to the first electrode strip E1; that is to say, at least a second part PB1 is provided between the fourth part PA2 and the first part PA1, so as to prevent the self capacitance value measured from the fifth electrode strip E5 from mutually interfering with the self capacitance value measured from the first electrode strip E1. Further, with the fifth electrode strip E5 provided, multi-region detection can be provided when the region of a finger touch upon the fingerprint sensor 100 does not cover the entire fingerprint sensor 100. Similar to the arrangement of the first electrode strip E1 and the second electrode strip E2, the first axial electrode strip AE1 may further include at least one second part PB1, such that the fourth part PA2 may also be provided between two second parts PB1 and one second part PB1 may be provided between the fourth part PA2 and the adjacent third part PB2, thereby preventing the self capacitance value measured from the fourth part PA2 from interference of the fourth electrode strip E4. In this embodiment, no second electrode strip E2 is provided between two adjacent fifth electrode strips E5. In other embodiment, at least one second electrode strip E2 may also be provided between two adjacent fifth electrode strips E5. In other words, the fourth part may be further divided into at least two sub-parts, and the first axial electrode strips may further include another second part provided between the sub-parts of the fourth part, so as to separate the sub-parts.

After step S10, when the determining unit JU determines that a touch occurs on the fingerprint sensor 100, step S20 of fingerprint recognition is performed. In this embodiment, fingerprint recognition is operated based on mutual capacitance touch sensing of the fingerprint sensor 100. For example, in step S20, the control module CM may sequentially provide a plurality of driving signals to the first axial electrode strips AE1 of the fingerprint sensor 100, and receive sensing signals from the second axial electrode strips AE2 of the fingerprint sensor 100, so as to detect mutual capacitance values corresponding to ridges and valleys of a fingerprint to further obtain fingerprint information. It should be noted that, when the fingerprint sensor 100 operates on the basis of mutual capacitance touch sensing, in order to enable the driving signals provided to the first axial electrode strips AE1 to cause the second axial electrode strips AE2 to generate sensing signals, the total current of the driving signals provided by the control module CM needs to reach above a certain value. When the fingerprint sensor 100 operates on the basis of self capacitive touch sensing, the first voltage signal S1 provided to the first electrode strips E1 directly measures through the first electrode strips E1 the self capacitance value thereof, and the second voltage signal S2 provided to the second electrode strips E2 and the third voltage signal S3 provided to the third electrode strips E3 do not need to be measured. Thus, the total current of the first voltage signal S1, the second voltage signal S2 and the third voltage signal S3 provided by the control module CM may be smaller than a total current for providing driving signals. That is to say, the peak voltage of the driving signals is greater than the second voltage V2 of the first pulse PU1 of the first voltage signal S1. For example, the total current for providing the first, second and third voltage signals S1, S2 and S3 may be 3 mA, and the total current for providing driving signals may be 30 to 40 mA. It is known that, compared to mutual capacitive touch sensing, detecting whether a finger touches the fingerprint sensor 100 through self capacitive touch sensing effectively reduces the power consumption. Further, since mutual capacitive touch sensing is performed only after it is detected that a finger touches the fingerprint sensor 100, the fingerprint sensor 100 boosts the output current capability through a charge pump such that the value of the current provided is sufficient for measuring a fingerprint.

Step S30 may be performed after step S20 to repeat self capacitive touch sensing for at least once to further detect whether a touch occurs at the fingerprint sensor 100. That is to say, after completing fingerprint recognition, the control module CM again provides the first voltage signal S1 to each of the first electrode strips E1 and the second voltage signal S2 to each of the second electrode strips E2, and again measures the self capacitance value of each first electrode strip E1 to detect whether a touch occurs at the fingerprint sensor and to determine whether other operations need to be performed. The number of times of repeating self capacitive touch sensing may be, for example but not limited to, plural. In this embodiment, the step of performing self capacitive touch sensing and the step of the performing mutual capacitive touch sensing are non-overlapping.

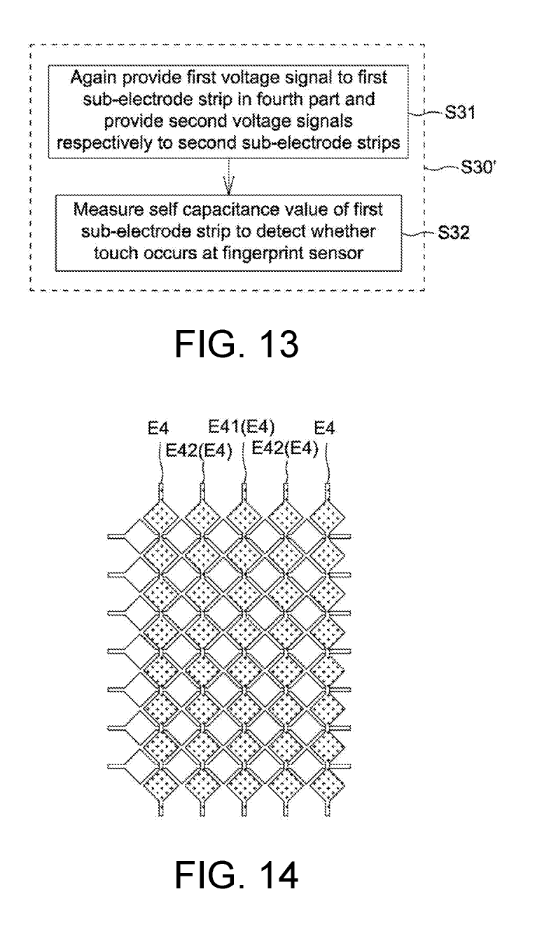

In another embodiment, as shown in FIG. 13 and FIG. 14, in the step of performing different rounds of self capacitive touch sensing, the first voltage signal S1 may be provided to different first axial electrode strips AE1, and the second voltage signal S2 may also be provided to different first axial electrode strips AE1. More specifically, the fourth electrode strips E4 may include at least one first sub-electrode strip E41 and at least two second sub-electrode strips E42, wherein the first sub-electrode strip E41 is provided between the two second sub-electrode strips E42. In step S30′, step S31 is performed to again provide the first voltage S1 to the first sub-electrode strip E41 of the fourth part PB2 and the second voltage signal S2 to each of the second sub-electrode strips S42, and then step S32 is performed to measure the self capacitance value of the first sub-electrode strip E41 to detect whether a touch occurs at the fingerprint sensor 100.

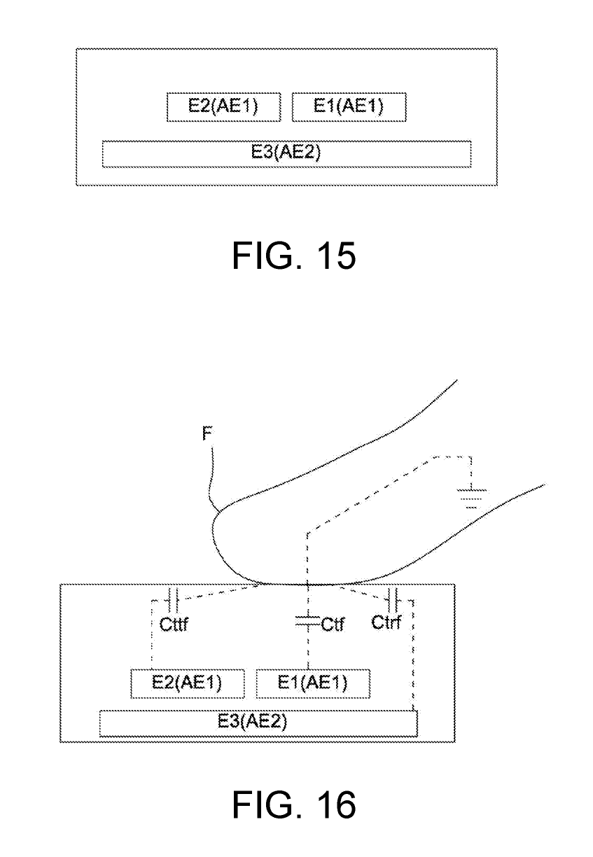

More specifically, FIG. 15 and FIG. 16 show schematic diagrams of coupling capacitance of a first electrode strip in regard to a second electrode strip and a third electrode strip before and after a finger touch, respectively. As shown in FIG. 15, before the fingerprint sensor 100 is touched by a finger, because the voltage difference between the first electrode strip E1 and the second electrode strip E2 and the voltage difference between the first electrode strip E1 and the third electrode strip E3 are kept at 0, and self capacitance value Cn′ of each first electrode strip E1 is 0.

As shown in FIG. 16, after the fingerprint sensor 100 is touched by a finger, although the finger generates capacitance coupling with each first electrode strip E1, each second electrode strip E2 and each third electrode strip E3, since there is no coupling capacitance between each second electrode strip E2 in regard to each first electrode strip E1 and each third electrode strip E3, the self capacitance value Ct′ of each second electrode strip E2 is only the coupling capacitance Ctf between each first electrode strip E1 and the finger F. Thus, the self capacitance change ΔC′ of each second electrode strip E2 before and after the finger touch on the fingerprint sensor 100 is only the coupling capacitance Ctf. It is known that, the self capacitance change ΔC′ measured in this embodiment is not associated with the coupling capacitance between each first electrode strip E1 and each second electrode strip E2 and is not associated with the coupling capacitance between each first electrode strip E1 and each third electrode strip E3.

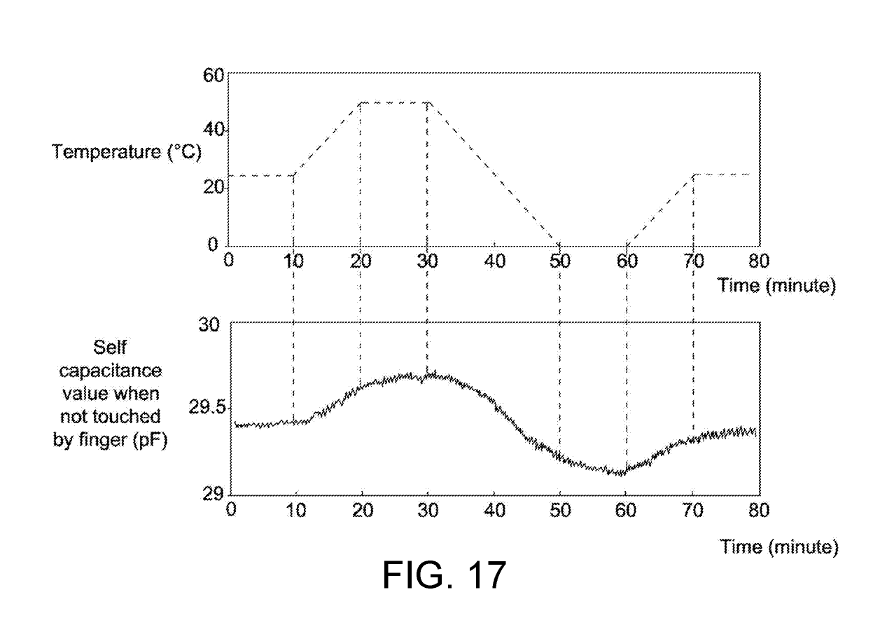

Refer to FIG. 17 as well as Table-2 below. FIG. 17 shows a schematic diagram of a relationship curve of temperature versus time and a relationship curve of self capacitance value measured from all first electrode strips versus time when a fingerprint sensor is not touched by a finger in a driving method according to the second embodiment of the present invention. Table-2 shows the self capacitance values when not touched and touched by a finger touch, the self capacitance change, the residual sensing amount and a difference between the residual sensing amount and when not touched by a finger in a driving method according to the first and second embodiments of the present invention. As shown in FIG. 17, when the temperature rises from 25 degrees to 50 degrees Celsius, the self capacitance rises by 0.29 pF; when the temperature drops from 50 degrees to 0 degree Celsius, the self capacitance drops by 0.55 pF. It is evident that, with the driving method of the embodiment, the change in the self capacitance when the fingerprint sensor 100 is not touched by a finger (i.e., the so-called background capacitance value) due to the change in the temperature, compared to the first embodiment, is reduced by 60%. Further, the driving method of this embodiment reduces the value of the self capacitance value Cn′ when the fingerprint sensor 100 is not touched by a finger, thereby significantly reducing the influences of the background capacitance value on the self capacitance change. Further, as shown in Table-2, with the driving method of this embodiment, the self capacitance change when touched and not touched a finger touch is, e.g., about 2.97 pF, which is higher than the self capacitance change in the first embodiment, and thus the driving method of the embodiment is capable of more accurately identifying a finger touch. Because the self capacitance change in response to a temperature change when the fingerprint sensor 100 is not touched by a finger is smaller than the self capacitance value measured, whether or not the result of the fingerprint sensor 100 indicates a finger touch is not likely affected by the temperature change.

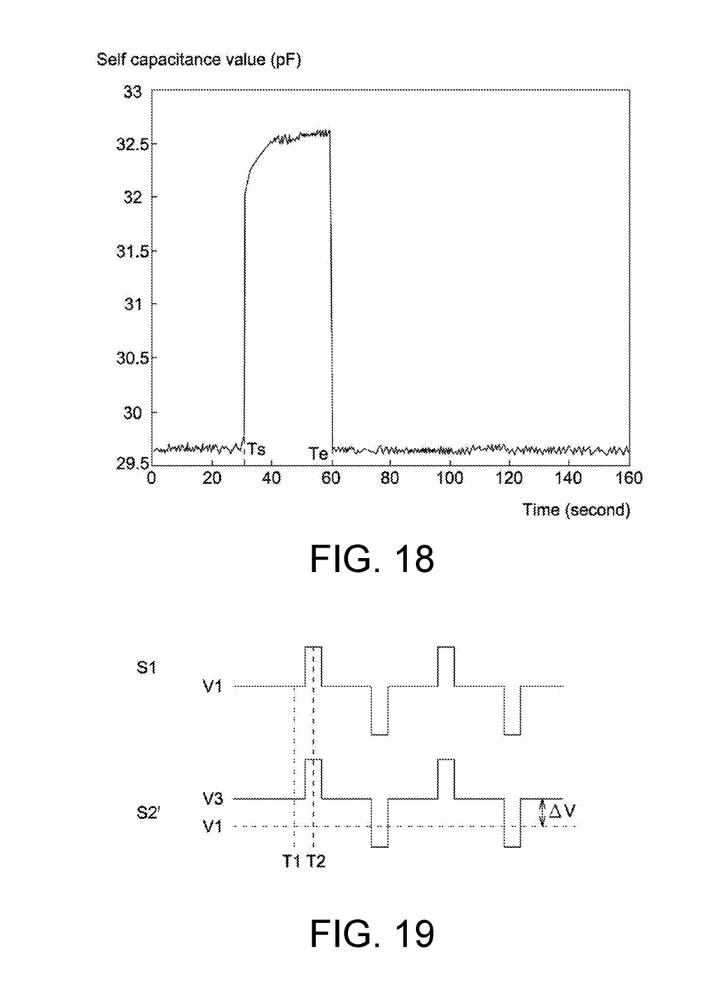

Refer to FIG. 18 as well as Table-2 below. FIG. 18 shows a relationship schematic diagram of self capacitance value measured versus time when a fingerprint performs self capacitive touch sensing according to the second embodiment of the presentation. As shown in FIG. 18, compared to FIG. 6 of the first embodiment, the self capacitance value measured at an ending time point Te when a finger has just left the fingerprint sensor 100, e.g., 29.65 pF, is close to the self capacitance value measured when the finger has not yet touched the fingerprint sensor 100, e.g., 29.63 pF. Thus, the period that the fingerprint sensor 100 misjudges that a finger is still touching the fingerprint sensor 100 can be minimized, thereby increasing the speed by which the fingerprint sensor recognizes a finger again touches the fingerprint sensor 100, e.g., accelerating the speed of performing unlocking for the fingerprint sensor 100.

TABLE 2

| | First | Second |
|---|---|---|
| | embodiment | embodiment |
| Self capacitance value when not | 118.5 | 29.63 |
| touched by finger (pF) | | |
| Self capacitance value when | 120.1 | 32.6 |
| touched by finger (pF) | | |
| Self capacitance change (pF) | 1.6 | 2.97 |
| Residual sensing amount after | 119 | 29.65 |
| finger has just left (pF) | | |
| Difference between residual | 0.5 | 0.02 |
| sensing amount and when not | | |
| touched by finger (pF) | | |

FIG. 19 is a timing diagram of a first voltage signal and a second voltage signal according to a third embodiment of the present invention. As shown in FIG. 19, compared to the second embodiment, a bias voltage ΔV may be present between the first voltage signal S1 and a second voltage signal S2′. For example, the first voltage signal S1 and the second voltage signal S2′ may have the same frequency, phase and amplitude; further, in this embodiment, the second voltage signal S2′ may have a third voltage V3 at the first time point T1, and the difference between the third voltage V3 and the first voltage V1 of the first voltage signal S1 at the first time point T1 is the bias voltage ΔV. Because the bias voltage also exists between the first voltage signal S1 and the second voltage signal S2′ at the first time pint T1 and the same bias voltage ΔV exists between the first voltage signal S1 and the second voltage signal S2′ at the second time point T2, i.e., the bias voltage ΔV is continually maintained between the first voltage S1 and the second voltage S2′, the cross voltage of coupling capacitance between the first electrode strip E1 and the second electrode strip E2 before and after the measurement is not at all changed. As a result, the amount of charge stored in the coupling capacitance is not changed either. As such, the first voltage signal S1 only charges/discharges the self capacitance of the first electrode strip E1, and the correspondingly measured charged/discharged charge can be linearly reflected in the self capacitance value. In another variation embodiment, the first voltage signal S1 and the second voltage signal S2′ may be swapped. In another variation embodiment, the second voltage signal S2′ in the third embodiment may also be applied as any of the first voltage signal, the third voltage signal and the fourth voltage signal in the second embodiment.

In conclusion, in the fingerprint sensing device and the driving method of a fingerprint sensor of the present invention, the fingerprint achieves objects of fingerprint sensor activation and fingerprint recognition, and further reduces a self capacitance value when the fingerprint sensor is not touched by a finger and the change in the self capacitance value due to temperature change, thus preventing misjudgment of the fingerprint sensor under a temperature change, accelerating an unlocking time for the fingerprint sensor and enhancing user convenience.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving method of a fingerprint sensor, the fingerprint sensor comprising a first electrode strip, at least two second electrode strips adjacent to the first electrode strip, and a plurality of third electrode strips intersecting the second electrode strips, for detecting a fingerprint, the driving method comprising:
providing a first voltage signal to the first electrode strip, and simultaneously providing at least two second voltages respectively to the second electrode strips; and
measuring a self capacitance value of the first electrode strip to determine whether a touch occurs at the fingerprint sensor;
wherein, the first voltage signal and each of the second voltage signals have a first voltage difference at a first time point and have a second voltage difference at a second time point, the first voltage difference and the second voltage difference are substantially equal, and the self capacitance value of the first electrode is measured at the second time point.

2. The driving method of a fingerprint sensor according to claim 1, further comprising providing a plurality of third voltage signals respectively to the third electrode strips when providing the first voltage, wherein the first voltage signal and each of the third voltage signals have a third voltage difference at the first time point and a fourth voltage difference at the second time, and the third voltage difference and the fourth voltage difference are substantially equal.

3. The driving method of a fingerprint sensor according to claim 2, wherein the first voltage signal, each of the second voltage signals and each of the third voltage signals are substantially the same.

4. The driving method of a fingerprint sensor according to claim 1, wherein when the self capacitance value is smaller than a predetermined threshold, it is determined that no touch occurs at the fingerprint sensor.

5. The driving method of a fingerprint sensor according to claim 1, wherein when the self capacitance value is greater than or equal to a threshold, it is determined that a touch occurs at the fingerprint sensor.

6. The driving method of a fingerprint sensor according to claim 1, further comprising performing fingerprint recognition when it is determined that a touch occurs at the fingerprint sensor.

7. The driving method of a fingerprint sensor according to claim 6, wherein the fingerprint recognition is performed by means of mutual capacitive touch sensing with the fingerprint sensor.

8. The driving method of a fingerprint sensor according to claim 6, further comprising:
after the fingerprint has been recognized, again providing the first voltage to the first electrode strip, and providing the second voltage signals respectively to the second electrode strips; and
again measuring the self capacitance value of the first electrode strip to detect whether a touch occurs at the fingerprint sensor.

9. The driving method of a fingerprint sensor according to claim 1, wherein the fingerprint sensor further comprises three fourth electrode strips, which are parallel to the first electrode strip and are sequentially arranged, the driving method further comprising:
after the fingerprint has been recognized, again providing the first voltage signal to an intermediate among the four electrode strips, and providing the second voltage signals to two other among the fourth electrode strips; and
measuring a self capacitance value of the intermediate among the four electrode strips to detect whether a touch occurs at the fingerprint sensor.

10. The driving method of a fingerprint sensor according to claim 1, wherein the fingerprint sensor further comprises another first electrode strip, and no second strips are provided between the two adjacent first electrode strips.

11. The driving method of a fingerprint sensor according to claim 1, wherein the fingerprint sensor further comprises another first electrode strip, and at least one of the second strips is provided between the two adjacent first electrode strips.

12. The driving method of a fingerprint sensor according to claim 1, wherein the fingerprint sensor further comprises a fifth electrode strip, which is parallel to the first electrode strip and is separated from the first electrode strip, one of the second electrode strips is provided between the first electrode strip and the fifth electrode strip, and a fourth voltage signal is provided to the fifth electrode strip.

13. The driving method of a fingerprint sensor according to claim 12, wherein the fourth voltage signal and the first voltage signal are substantially the same.

14. The driving method of a fingerprint sensor according to claim 1, wherein the first voltage signal has a first voltage at the first time point and a second voltage at the second time point, and the second voltage is greater than or equal to the first voltage.

15. A fingerprint sensor device, comprising:
a fingerprint sensor, comprising a first electrode strip, at least two electrode strips adjacent to the first electrode strip, and a plurality of third electrode strips intersecting the second electrode strips; and
a control module, electrically connected to the fingerprint sensor, providing a first voltage signal to the first electrode strip, at least two second voltage signals respectively to the second electrode strips, and measuring a self capacitance value of the first electrode strip, wherein first voltage signal and each of the second voltage signals have a first voltage difference at a first time point and have a second voltage difference at a second time point, the first voltage difference and the second voltage difference are substantially equal, and the self capacitance value of the first electrode is measured at the second time point.

16. The fingerprint sensor device according to claim 15, further comprising:
a determining unit, electrically connected to the control module, determining whether a touch occurs at the fingerprint sensor according to the self capacitance value of the first electrode strip and measured by the control module.

17. The fingerprint sensor device according to claim 15, wherein the control module further provides a plurality of third voltage signals respectively to the third electrode strips, the first voltage signal and each of the third voltage signals have a third voltage difference at the first time point and a fourth voltage difference at the second time point, and the third voltage difference and the fourth voltage difference are substantially equal.

18. The fingerprint sensor device according to claim 15, wherein the fingerprint sensor performs fingerprint recognition by means of mutual capacitive touch sensing.

19. The fingerprint sensor device according to claim 15, wherein the fingerprint sensor further comprises another first electrode strip, and no second electrode strips are provided between two adjacent first electrode strips.

20. The fingerprint sensor device according to claim 15, wherein the fingerprint sensor further comprises another first electrode strip, and at least one of the second electrode strips is provided between two adjacent first electrode strips.

21. The fingerprint sensor device according to claim 15, wherein the fingerprint sensor further comprises a fifth electrode strip, which is parallel to the first electrode and separated from the first electrode strip, one of the second electrode strips is provided between the first electrode strip and the fifth electrode strip, and the control module further provides a fourth voltage signal to the fifth electrode strip.
